(19) United States
(12) Patent Application Publication
(10) Pub. No.: US 2018/0164666 A1
(43) Pub. Date: Jun. 14, 2018

(54) Articulating Projector Mount

(71) Applicant: Muhannad Salem Alturk, Amman (JO)

(72) Inventor: Muhannad Salem Alturk, Amman (JO)

(21) Appl. No.: 15/376,503

(22) Filed: Dec. 12, 2016

(51) Int. Cl. G03B 21/14; F16M 13/02; F16M 11/14; F16M 11/18; F16M 11/42; A47C 21/00; A47C 31/00

(52) U.S. Cl. CPC G03B 21/145; F16M 13/022; F16M 11/14; A47C 31/008; F16M 11/42; A47C 21/003; F16M 11/18

(57) ABSTRACT

An articulating projector mount has one or more mounting rods each with a first and second end. The first end is pivotally mounted to a projector and the second end terminates in a base. The base is pivotally mounted to, and releasably engages, an attachment. The pivotal mountability of the mountings rods to the projector is accomplished by a spheroidal joint. A male component of the mounting rod engages with a female component of the spheroidal joint. A remote is in communication with the projector mount and projector. A motor and wiring within the projector mount allow for remote control of the mounting rods and projector orientation.

### BACKGROUND OF THE INVENTION

### 1. Field of Invention

The present invention relates to the field of projectors and particularly to the field of mountable articulating projectors used for reading.

### 2. Description of Related Art

Throughout the world, many people have the beneficial habit of reading. It is a great way to acquire information, relax after a long day, and temporarily escape reality. Of course, books have been around for millennia and are still used today while advances in technology has given us tablets, and other forms of electronic reading.

It is common practice to read while in bed to help one wind down and fall asleep. Using a book requires the reader to leave lights on or use a reading light. Once the reader becomes tired, they must then get up and turn off the lights, which can promote wakefulness and restart the sleep process. Tablets and other electronic reading devices can allow the reader to read with the lights off, however like the book, they must prop the book up, or hold the book in a viewable position while lying down. This can be uncomfortable if performed for long periods of time and can disturb others in the room.

Books require the user to dedicate large amounts of space in their home to store them. As the collection grows, so must the amount of storage space. Often, many books sit in storage for years without being used, resulting in wasted space. To mitigate this, digital alternatives are becoming more and more popular, allowing users to digitally download books and store them as memory on a hard drive.

Projectors have been used for watching television, movies, presentations, and other forms of media. They are typically mounted in a fixed position and the image is projected across the room. Generally, projectors are mounted to a ceiling and the image is projected onto a vertical wall. These devices are expensive, fragile, and difficult to maneuver and are often placed in a public space where they can be viewed by large groups of people. It would be valuable to have a simple, lightweight, easy-to-use projector that is designed for personal use. A suitable solution is desired.

Based on the foregoing, there is a need in the art for a projector that can be easily mounted to a bed frame and display reading material either on the ceiling, or a wall as determined by the user. Further, the projector should be able to have wireless connectivity to information sources as well as BUS, such as USB and Micro SD, inputs so that a user may download materials and display through the projector.

### SUMMARY OF THE INVENTION

An articulating projector mount comprises one or more mounting rods, each of which having a first and second end. The first end is pivotally mounted to a projector, and the second end terminates in a base. The base is pivotally mounted to an attachment, such as a clamp, magnet, and rolling apparatus.

In an embodiment, the first end of the one or more mounting rods terminates in a male component. The projector has a female component that engages with the male component of each of the mounting rods, forming a spheroidal joint.

In an embodiment, the base releasably engages the attachment, such that the user can change bases for multiple functions.

In an embodiment, the projector has a bottom surface, allowing for the projector be pivotally mounted to the first end of each of the mounting rods. In further embodiments, the projector comprises one or more side surfaces, wherein each of the side surfaces is pivotally mounted to each of the mounting rods.

In an embodiment, each mounting rod has one or more pivoting joints along a length of the mounting rods. In further embodiments, a remote allows for remote electrical communication with a motor and wiring within the projector and mounting rods.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the projector mount affixed to a headboard, according to an embodiment of the present invention;

FIG. 2 is a front elevation view of the projector and projector mount, according to an embodiment of the present invention;

FIG. 3 is a perspective view of the projector mount affixed to a surface, according to an embodiment of the present invention;

FIG. 4 is a perspective view of the projector mount affixed to a headboard, according to an embodiment of the present invention;

FIG. 5 is a perspective view of the projector mount affixed to a surface, according to an embodiment of the present invention; and

FIG. 6 is a front elevation view of the projector and projector mount, according to an embodiment of the present invention.

### DETAILED DESCRIPTION OF PREFERRED EMBODIMENTS

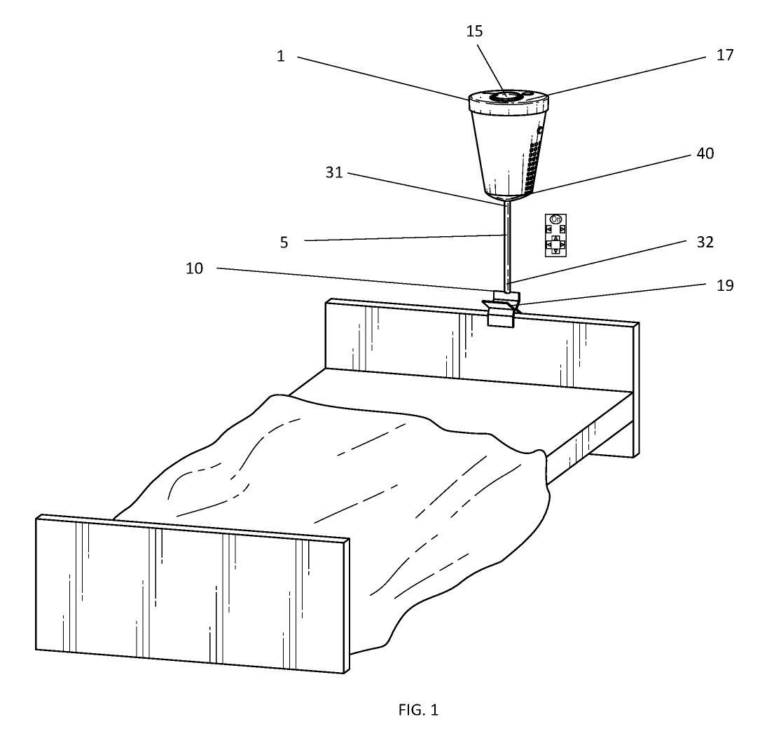

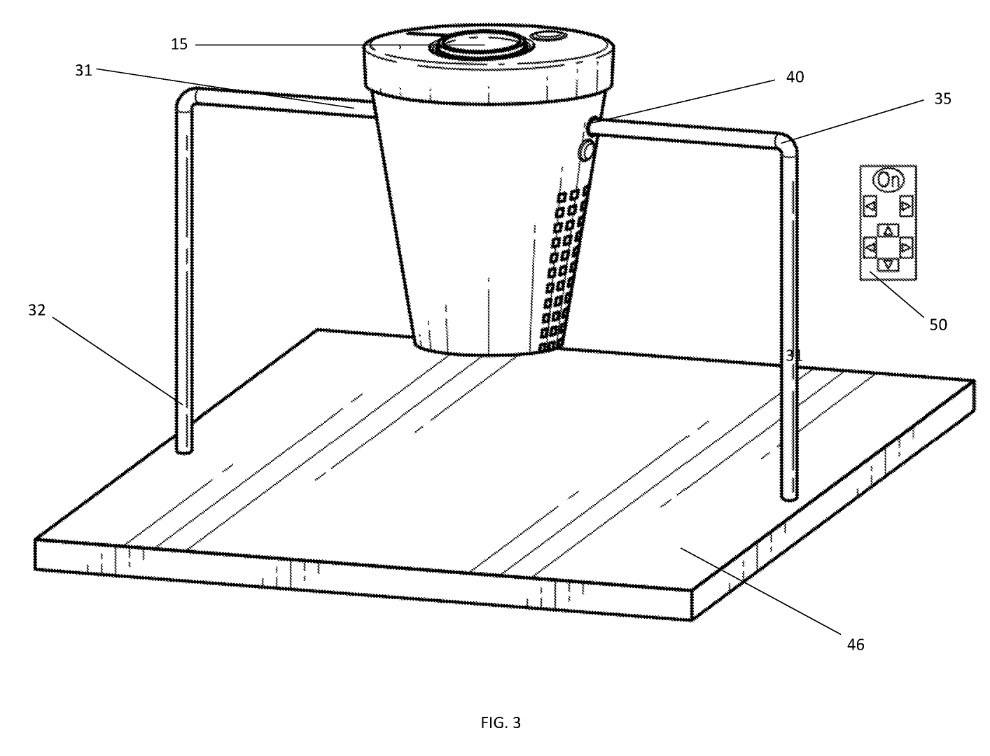

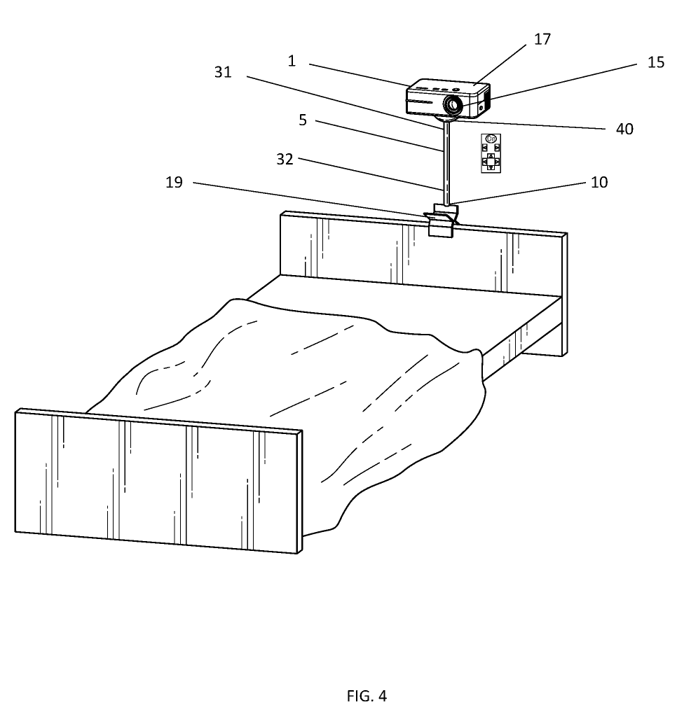

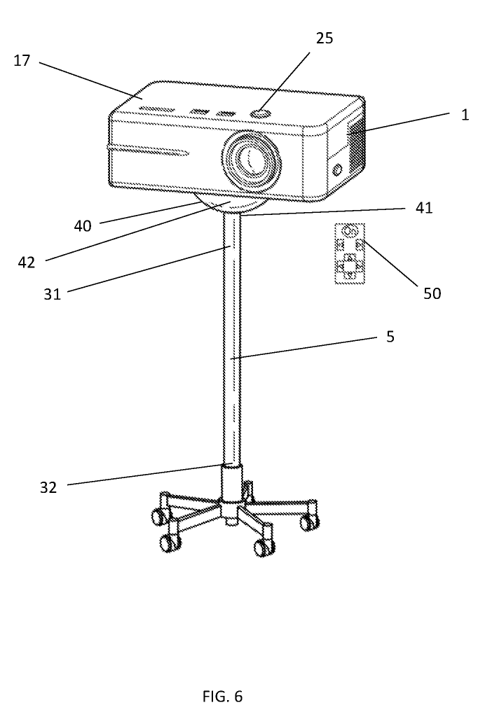

Preferred embodiments of the present invention and their advantages may be understood by referring to FIGS. 1-6, wherein like reference numerals refer to like elements.

The present invention, in general, relates to a mountable, articulating projector that has the ability to connect wirelessly to other devices as well as or physically connect to BUS inputs. The purpose of the projector is to project reading materials from a mounted position, onto a wall or ceiling. The projector mount should be simple, inexpensively produced, and lightweight so that it can be mounted to many different objects and locations.

Preferentially, the projector comprises a body 1, with a plurality of optical components disposed within. As known in the art the body comprises; one or more memory units, one or more processors, a shaping lens, a condensing lens, a light source, and projection lens. These components work in series to project an image onto a screen, wall, or other smooth surface. Other means of displaying an image as known in the art may be used.

In a preferred embodiment, the body 1 is generally cuboid. A face 15 comprises the lens which projects light that forms an image onto the surface. The lens has one or more focusing components, allowing the user to focus the image reading material on the surface. The body is further defined by a top 17, which comprises one or more control panels. Each control panel has one or more buttons or data inputs 25 such as but not limited to; ON/OFF, wireless connectivity—such as Bluetooth—a micro SD insert and USB or other BUS insert. Wireless connectivity or BUS inputs allow for the user to pre-download reading materials and then display the material using the projector.

The body 1 is separated from a base 10 by one or more mounting rods 5. Each mounting rod allows the body 1 to be oriented in different directions. In an embodiment, the projector can rotate 360° allowing the face 15 and therefore the lens to project an image in any direction in a 360° plane. Further, the mounting rods 5 can be bent allowing for the body 1 to project an image at any angle. This allows the user to display the reading material vertically or horizontally, each of which either on a vertical or horizontal surface depending on the users preference.

In reference to FIGS. 1-6, Two ends define each mounting rod; a first end 31 is in communication with the body and can allow the body to articulate, while a second end 32 is terminates at a base 10. In a preferred embodiment, the mounting rod is pivotally mounted to the body 1, at the first end 31, and an attachment 19, at the second end 32. The first end 31 terminates in a spheroidal joint 40 in communication with the body 1 of the projector. Each spheroidal joint 40 allows for the projector to rotate at the point of contact between the first end 31 of each mounting rod 5 and the body 1. The spheroidal joint has a male component 41 and a female component 42. The female end 41 is integrally molded or attached to the projector body. The second end of the mounting rod terminates in the male end of the spheroidal joint. In an embodiment, each mounting rod comprises one or more pivoting joints 35, allowing for the orientation of the projector to be fully adjusted. In an embodiment, the mounting rod 5 is able to telescope, allowing for the projector to be raised and lowered by the user.

The attachment 19 may include a clamp, magnets, or a rolling apparatus. A variety of attachments allow for the mount to be positioned in a variety of areas and at varying orientations. Each embodiment of the attachment releasably engages the base of the mounting member. In alternate embodiments, each of the mounting rods terminates in, and is permanently affixed to a surface 46.

In an embodiment, each mounting rod comprises one or more pivoting joints 35, allowing for the orientation of the projector to be fully adjusted.

In an embodiment, the mounting rod 5 is able to telescope, allowing for the projector to be raised and lowered by the user.

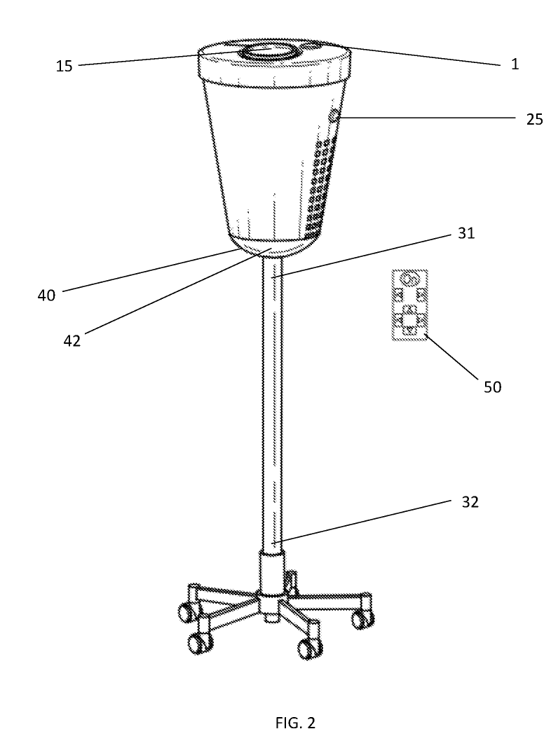

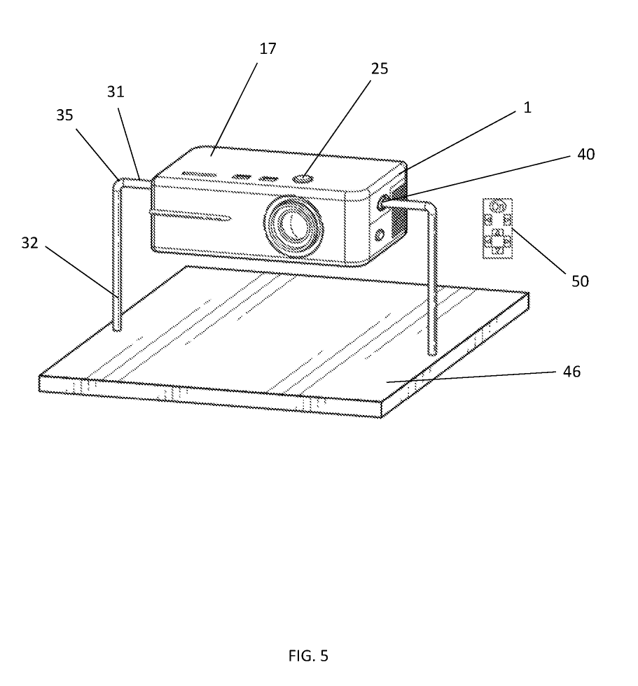

In reference to FIG. 2 and FIG. 5, two opposing mounting rods extend from a first side and a second side of the base. The mounting rods connect each side of the base with opposing first and second sides of the projector body 1. Mounting at each side of the projector allows the body to rotate about an axis created by the two opposing mounting rods. Each side of the projector further comprises a swivel mount that matingly engages with the mounting rods allowing for the body to articulate. The mounts and projector are shown releasably engages with a magnet attachment. In an embodiment, pivoting joints 35, are disposed along a length of each of the one or more mounting rods.

The base extends perpendicular to the mounting rods, however, the base may also articulate, changing the angle between the mounting rods and base and therefore the projection of the image. In a preferred embodiment, the base can either rest on a surface, or be releasably engages to a surface such as the headboard of a bed.

In an alternate embodiment, the base is magnetized and is able to engage a corresponding magnetized base component. The magnetic attraction between the corresponding base pieces allow for the base to be mounted to a wide range of surface.

In an embodiment, the base comprises a clamping mechanism, such as a spring clip, or other means of attachment known in the art. The clamping mechanism allows for the device to be releasably engaged with one of a plurality of surfaces that are convenient for the user. The spring clip has two members forced together by a spring. It offers a quick, non-permanent, releasable means of engaging the projector with a surface.

In a preferred embodiment, a remote control 50 is in wireless communication with the projector allowing the user to control features such as but not limited to; ON/OFF functions, light intensity, zoom in and out, and left or right page turning. In use, the user can fully manipulate the projector using only the remote.

In an embodiment, the wireless connectivity of the projector allows the projector to connect with cloud-based data storage. In use, the user is able to scroll through a list of reading materials such as books, magazines, or blogs. The user can then select desired reading materials and either download or view documents from the data source.

In an alternate embodiment, the articulating projector mount further comprises a motor and wiring that are each in communication with the mounting rods. The motor allows the mounting rods to be manipulated by the remote so that the user can adjust the orientation of the projector. Other embodiments of a motor and wiring may be used as known in the art, so long as the mounting rods are remotely adjustable.

In an embodiment, the user is able to control the orientation of the projector using the remote. For example, the user could manipulate the orientation such that the projected image can be moved from a wall, to a ceiling as the user decides to turn between lying on their side and their back. Further, all other functionality of the projector is accessible by the remote.

In an embodiment, the projector is in wireless communication with a server, the server allows for the projector to access information stored in the server. For example, the user may access reading material stored in the server, forgoing the need to download the reading material to a hard drive. In a further embodiment, the projector has a corresponding app that can access information databases and servers that contain reading material. For example, the user can use pre-existing services such as Amazon Books to access reading materials and display through the projector. Integration with other smart devices both with a hard-wired connection and wirelessly expands the potential for the projector and allows the user further access to reading materials.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. An articulating projector mount comprising:
a. one or more mounting rods, wherein each mounting rod has a first end and a second end, wherein the first end is pivotally mounted to a projector, and wherein the second end terminates in a base; and
b. an attachment, wherein the attachment pivotally mounts to the base, wherein the attachment is selected from a group consisting of; one or more clamps, one or more magnets, and a rolling apparatus.

2. The articulating projector mount of claim 1, wherein the first end of each of the one or more mounting rods is pivotally mounted to the projector by a spheroidal joint.

3. The articulating projector mount of claim 2, wherein the first end of each mounting rod terminates in a male component of the spheroidal joint, wherein the female component of the spheroidal joint is engaged with the projector.

4. The articulating projector mount of claim 1, wherein the base releasably engages the attachment.

5. The articulating projector mount of claim 1, having one or more pivoting joints disposed along a length of each mounting rod.

6. The articulating projector mount of claim 1, wherein the projector comprises a bottom surface, wherein the bottom surface is adapted to receive the first end of the mounting rod.

7. The articulating projector mount of claim 1, wherein the projector comprises one or more side surfaces, wherein at least one of the side surfaces is adapted to receive the first end of the mounting rod.

8. The articulating projector mount of claim 1, wherein a remote is in communication with the projector and articulating projector mount.

9. The articulating projector mount of claim 7, wherein a motor and wiring are in communication with each of the one or more mounting rods, having wireless connectivity.
